(19) United States
(12) Patent Application Publication
(10) Pub. No.: US 2011/0041395 A1
(43) Pub. Date: Feb. 24, 2011

(54) Integrated Agriculture and Aquaculture Production System

(75) Inventors: Richard Newbold, Philadelphia, PA (US); Janusz Kozinski, Toronto (CA)

Correspondence Address: Leason Ellis LLP, 81 Main Street, Suite 503, White Plains, NY, 10601, US

(73) Assignee: BioSynEnergy LLC, Doylestown, PA (US)

(21) Appl. No.: 12/860,753

(22) Filed: Aug. 20, 2010

Related U.S. Application Data
(60) Provisional application No. 61/235,413, filed on Aug. 20, 2009.

(51) Int. Cl. A01G 1/00; A01G 9/14; C10J 3/48

(52) U.S. Cl. 47/1.4; 47/1.1 R; 47/17; 47/58.1 R

(57) ABSTRACT

The present invention concerns a system for the production of high yield agricultural and aquaculture products using separate, discrete and scalable production units that cooperate to provide a low carbon food production facility. A combination of greenhouses, hydroponic farms, fish hatcheries and on-site pyrolysis-gasification generators is used to produce and consume almost all the necessary materials from a feed stock of municipal waste, and other forms of carbon-containing waste feed stocks.

### RELATED APPLICATION

The present application herein derives an earlier priority date to U.S. Provisional Application No. 61/235,413 filed Aug. 20, 2009, which is hereby incorporated by reference.

### BACKGROUND OF THE INVENTION

The present invention relates to generally to agriculture and aquaculture systems combined with energy co-generation facilities and, more particularly, to aquaculture tanks and sealed agricultural facilities that employ the electrical energy, heat and CO₂ generated from combustion of waste streams to operate in an ecologically sound manner, and minimize the need for material input.

### FIELD OF THE INVENTION

To the extent that specific publications are discussed herein, they are all hereby incorporated by reference into this document in their respective entireties.

Aquaculture is the controlled cultivation of aquatic flora and fauna. Agriculture is the cultivation of plants, with or without the use of a soil medium. Combined agriculture/aquaculture systems are currently known in the art. For Example U.S. Pat. No. 6,065,245 to Seawright is directed to integrated aquaculture-hydroponics systems. Seawright is directed to maintaining a concentration of useful minerals in the water streams used in the hydroponic and aquaponic systems. A drawback of the Seawright patent is that it is not directed to also incorporating a gasification-pyrolysis co-generation unit into the overall structure. A further drawback is that the facilities used by Seawright are not scalable to industrial production levels.

Combining low-carbon energy generation technologies with food production facilities is already known in the prior art. Devices that combine renewable energy generators and aquaculture systems are detailed in prior art references such as U.S. Patent Application 2009/0301399 to Brown, and U.S. Patent application US 2009/0300983 to Tilford. Tilford is directed to using solar renewable energy to assist powering a greenhouse. Brown is directed at using bio-fuels to generate electricity to run fish and plant factory.

A drawback readily apparent in Tilford is that the method of energy generation is a single source. Solar energy is only available in usable quantities at specific times of the day in certain geographic regions. Furthermore, the greenhouse envisioned by Tilford requires reliance of sunlight for both power and as a necessary input to plant life. Brown is limited to the use of bio-fuels that require external production.

What is needed is a reliable power source coupled to an aquaponic and hydroponic system that has a wider range of available power options.

What is also needed is a combined agriculture and aquaculture system that is not dependent on exterior climate conditions for both plant growth and power is also required.

Classical agriculture and aquaculture systems are resource intensive operations. They require large expenditures of both water and energy in order to function properly. The systems themselves are not efficient, allowing for various waste streams to return untreated to the environment. What is needed is a combined agriculture and aquaculture system that allows for recycling and treatment of waste within the system itself. In that way, the overall energy requirements and raw material inputs can be minimized.

Non-renewable energy sources, including fossil fuels, are currently the primary source of electrical energy for agriculture and aquaculture systems. Given the demands on electrical infrastructure, it is desirable to provide a self contained energy generation unit coupled to the combined agriculture and aquaculture system. Therefore, what is lacking in the prior art is a system that employs renewable energy generation facilities to operate and power a combined agriculture and aquaculture system.

Hydroponic and agricultural greenhouses are dependent on external environmental factors to aid in plant growth. Heat, nitrogen, carbon dioxide and sunlight are necessary conditions for the proper cultivation of plant life. What is needed is a plant cultivation system that is not dependent on external environmental conditions. Furthermore, what is needed is a cultivation system that enhances the growth of plant life by using ideal internal conditions, while producing and/or recycling it own plant growth factors.

### SUMMARY OF THE INVENTION

The object of the present invention is to provide high-yield agricultural and aquaculture production facilities powered by efficient combined heat, electrical energy and CO₂ generation technology, including using municipal waste streams as a primary source of fuel for pyrolysis-gasification. Furthermore, the present invention is directed to enhance agricultural and aquaculture production by the inclusion of CO₂ capture from the co-generation facilities as well as the aquaculture facilities and delivery technologies that create a semi-closed loop production facility.

The advantages of using a controlled aquaculture production system are readily apparent. By using the internal waste streams of a combined agriculture and aquaculture system to complement external waste sources, the present invention provides inputs to a co-generation power unit, useful by-products can be provided where necessary and expensive waste can be reduced to minimal levels.

It is the principal object of the present invention to link a renewable form of energy and CO₂ generation with energy and resource intensive food production facilities. The present invention achieves increased, high yield food production, by linking on-land fisheries and farms in a way that is more integrated than those systems presently known in the art. The present invention broadens the scope of the foods (both plant and marine) that are capable of being produced. Additionally, the present invention allows for significant increases in production, both in terms of size and harvest cycles, by controlled capture and use of carbon dioxide and other regulated inputs. Furthermore, by incorporating renewable energy based on municipal waste streams, it allows the products to have a more ready commercial adoption due to lower energy costs due to renewable energy savings and carbon capture credits.

The present invention is a controlled intensive, production system that allows for land-based aquaculture and agricultural production facilities to be connected to a pyrolysis-gasification energy production unit. Through this connection, electricity, CO₂ and heat are transferred to and from the aquaculture production facilities.

In turn, aquatic waste is transformed to a nitrogen-based, liquid-form fertilizer, with unusable residual waste added as additional fuel to generate electricity. As a by-product of using municipal and aquatic waste, the pyrolysis-gasification system produces excess water. Once filtered, this water can then be reintroduced into the aquaculture facility or into an agriculture facility. An additional by product of the pyrolysis-gasification process is the production of carbon dioxide (CO₂). The CO₂ is sequestered during production and transferred, along with electricity, to the agricultural facilities. The agricultural facilities themselves are sealed to maintain a desired ambient concentration of CO₂ to optimize plant growing conditions. Multiple different agricultural facilities can maintain different levels CO2 in the controlled and sealed growing space. Through this increased CO2 atmosphere, the hydroponic system is able to achieve a higher yield than would be available with a standard hydroponic or soil-based system. The system also includes CO2 recapture technology to restore CO2 levels to normal prior to introducing human workers into the sealed and controlled growing areas. The hydroponic system in turn transfers agricultural waste that is filtered and provided either as partial feed for fish or fuel for the pyrolysis-gasification system or as raw inputs to the hydroponic system.

The present invention is also directed to a novel method of producing high yield agricultural and aquaculture products by using a combined aquaculture and agriculture system to managing the introduction of gasses, particularly CO₂, into a sealed and controlled agriculture facility. The method is further directed to producing CO₂ and powering the integrated aquaculture and agriculture system by using municipal and biological waste feed stock in a pyrolysis-gasification co-generation facility.

The gas management method also includes capture and concentration of oxygen from fish respiration for compression and filtration for potential commercial resale and/or use in producing ozone for enhanced purification of recycled water.

It should be understood that various combinations, alternatives and modifications of the present invention could be devised by those skilled in the art. The present invention is intended to embrace all such alternatives, modifications and variances that fall within the scope of the appended claims.

The foregoing and other features of the present invention will be more readily apparent from the following detailed description and drawings of illustrative embodiments of the invention in which the woven guard device and its components are more particularly described with reference to specific figures co-generation unit.

### BRIEF DESCRIPTION OF THE DRAWINGS

FIG. 1 is a schematic block diagram of a system according to one embodiment of the invention, highlighting certain interconnected elements thereof.

FIG. 2 is an illustrative diagram of the invention, highlighting interconnected modules of the system in accordance with the invention.

FIG. 3 is a schematic block diagram of a system according to one embodiment of the invention, highlighting interconnected elements thereof.

### DESCRIPTION OF ILLUSTRATIVE EXEMPLARY EMBODIMENTS

By way of overview and introduction, the present invention concerns an on-site system 100 for the integrated production of high yield agricultural and aquaculture products. The system a series of discrete and scalable production units or modules that cooperate to provide for the production of consumable and commercial products. The present invention has an on-site power unit 102, an agricultural production unit 104, an aquaculture production unit 106, a filtration unit 108 and material and energy conduits 110, 112, 114 and 116 to produce a low-waste, self-sustaining food production system. Through its operation, the present invention can form a sustainable local production facility without external utilities or material requirements.

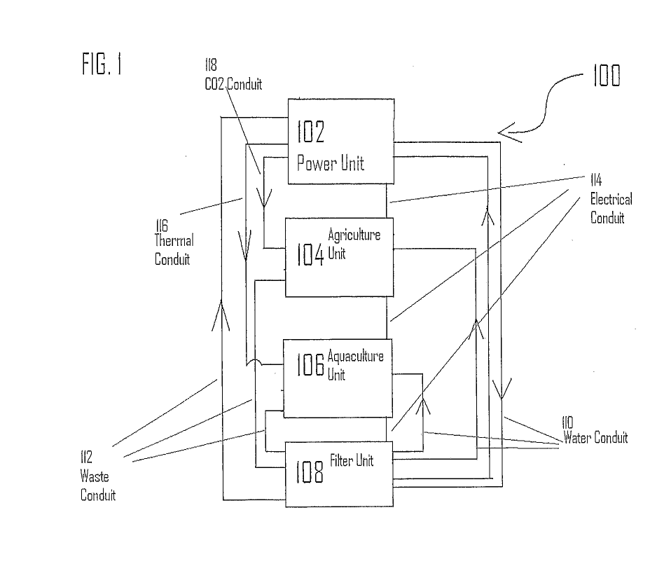

In an illustrative embodiment of the invention, as seen in FIG. 1, the aquaculture unit 106 and the agricultural production unit 104 are connected by various linkages to the on-site power unit 102 and the filtration unit 108. The power unit 102 has material transfer conduits 110, 112 and electrical and thermal conduits 114 and 116 that connect it to both the aquaculture unit 106 and agricultural unit 104. Furthermore, a municipal waste stream (not shown) serves as the primary fuel input to the system.

The power unit 102 uses an on-site pyrolysis-gasification generator as the primary source of electrical power. Pyrolysis and gasification generators are low-oxygen, variable temperature, variable operation time, non-combustion generators. They use biomass and other organic compounds as feed stock for producing syngas. Syngas can be used in standard generators for production of electricity. Through the pyrolysis-gasification operation, heat, electricity and CO₂ are generated for use as inputs for the other units in the system. The pyrolysis-gasification power generator is a sustainable, climate-independent, energy production unit configured to accept municipal, agricultural, forest-related and/or other carbon-containing commercial waste streams. By accepting municipal waste, the initial startup costs of importing fuel are minimized. The power unit requires carbon-containing materials for thermolysis (pyrolysis in the absence of oxygen) to operate, the type of which can readily be found in any municipality. For example, most municipal waste streams contain materials such as residual biomass (e.g, forest, agricultural and cellulosic construction/demolition materials), municipal solid waste, bio-solids (sewer sludges and other matter), animal carcasses, animal manure, fish waste, combustible medical waste, hazardous waste and industrial waste (including petroleum and other compounds). These materials can be used as input fuel for the pyrolysis-gasification unit either singly or in combination. The power unit 102 is broadly designed to be a commercially available or custom provided pyrolysis-gasification system or unit that is capable of being situated on-site, scaled to the energy needs of each aquaculture/agriculture production facility and accepting municipal waste systems as an input while generating at least CO₂, waste water, electricity and heat as outputs or by-products during its operation.

The power unit of the present invention can be configured to produce biochar. Biochar is a form of charcoal produced by thermolysis (oxygen-starved pyrolysis). The on-site pyrolysis-gasification generator can also be configured to produce biochar from selected biomass inputs when alternative electrical power sources are available at lower unit costs, During off-peak power utility hours, when the electrical requirements for the integrated system are low and the price of electricity sold to local connected utilities and customers is at off-peak rates, it is possible to reprogram the pyrolysis-gasification unit for the production of biochar and similar carbon-intensive, derivative materials. It is envisioned that the pyrolysis-gasification unit will use a selected form of biomass waste, limited to forestry, agricultural and wood-based construction waste. In this way, a high performance, scientifically validated soil amendment medium can be produced for sale to soil-based agricultural enterprises.

Electricity generated by the power unit 102 is used to operate all electrical devices needed to ensure proper operation of the production system 100. Electricity is transferred using common electrical conduits 114 and means of conduction electrical energy. Any excess electrical energy produced by the power unit 102 can be sold to the local utilities through a direct utility connection and monitors. In an alternative embodiment, the system 100 is not connected to a utility, use the excess electricity to charge external devices and machines, batteries or other electrical equipment through converters and adaptors. Additionally, in a further alternate embodiment, the power unit 102 uses pyrolysis-gasification system as well as other renewable energy production means (e.g. solar, wind, tidal, geothermal and similar means) or non-renewable energy generation (e.g. nuclear, natural gas, coal and similar means) to generate necessary electrical energy or heat. Furthermore, the system can draw electrical energy from the utility grid or additional energy production units.

Another by-product from the pyrolysis-gasification process is water. Whenever waste, either from municipal sources or internal sources, is prepared for pyrolysis-gasification, it is necessary to remove the excess moisture content. This is commonly done by evaporation through heating. The evaporated water can be collected and conveyed through material transfer conduits 110 to the filtration unit 108 for reuse by the system 100. Water is also introduced into the pyrolysis-gasification system, by material conduits 110, in the gasification phase to create syngas containing hydrogen, methane, carbon monoxide and carbon dioxide, and in a closed-loop, recirculating system for cooling the syngas prior to its use in power generation. If processed waste streams contain sufficient moisture (over 15% water content), the entire system can operate independent of external water supply.

Through the operation of the power unit 102, thermal energy is also produced. The thermal energy can be transferred from the power unit 102 to either the agricultural unit 104 or aquaculture unit 106. Thermal energy can be used to maintain a constant temperature of the water in the aquaculture unit 106, or to maintain the internal temperature of the agricultural unit 104. Conduction of thermal energy is accomplished by employing thermal transfer conduits 116. Thermal transfer conduits 116 can be heat exchangers, steam pipes, heating elements or other commonly understood thermal energy conductive apparatus. Additionally, the thermal energy produced during pyrolysis-gasification or thermolysis operations can be used to cool other units and areas within units, such as water directed to the aquaculture unit or the atmosphere of the agriculture unit. This is accomplished by action of chilling mechanisms, particularly special, non-compressors based, absorption chillers and other devices configured to absorb, dissipate or transfer thermal energy.

The present invention envisions at least one aquaculture 106 unit connected to the other components of the system 100. Preferred embodiments present invention envision more than one aquaculture unit 106 connected to the system 100. The aquaculture unit 106 is envisioned as having at least one marine life hatchery (not shown). It is conceived that the aquaculture unit 106 provides the necessary monitoring of conditions necessary for the successful growth and care of desired marine or aquatic life forms, including temperature, oxygen level, nitrogen levels, carbon dioxide levels, acidity level (pH), minerals and water purity. The aquaculture unit 106 possesses electrical connections 114 and thermal connections 116 between it and the power unit 102. These linkages provide heat and power to the aquaculture unit 106. Furthermore, the aquaculture unit 106 possesses waste conduits 112 and water conduits 110 for transporting waste and water to the filter unit 108.

It is envisioned that diverse species of fish, mollusks, plankton, algae, coruscations and other feasibly-raised aquatic life can be raised for production in the aquaculture unit 106. Furthermore, it is envisioned that facilities for the processing (e.g. filleting, freezing and packaging) of marine life are also provided within the aquaculture unit 106. In a preferred embodiment, transgenic and genetically engineered marine life, with enhanced qualities for survival in an aquaculture environment, are the primary species of fish raised. It is envisioned that the aquatic life would be engineered for enhanced disease resistance, tolerance for high density environments and growth rate.

The aquaculture unit 106 also is configured to collect waste generated during production and processing of marine and aquatic life form. The present invention uses the waste streams from the aquaculture unit 106 to provide biomass for energy generation purposes, as well as component for fertilizer and high nutrient feed stock. Fish excrement is collected at the bottom of tanks and is transmitted via conduits 110 to the filter unit 108 for sorting into nitrogen bases fertilizer or fuel stock. In this way, most materials are either recycled or used as an input stream for the power generation.

The agricultural unit 104 is configured to provide a monitored growing facility for high value agricultural products. Furthermore, each agricultural unit 104 possesses a specific atmospheric environment designed to maximize crop yield and growing times. Each agricultural unit 104 maintains a sufficient concentration of CO₂ so as to maintain optimal growing conditions. Agricultural waste produced in the agricultural units 104 can be transferred through material transfer conduits 112 to the filter unit 108, to be filtered for entry into feed and fuel stocks.

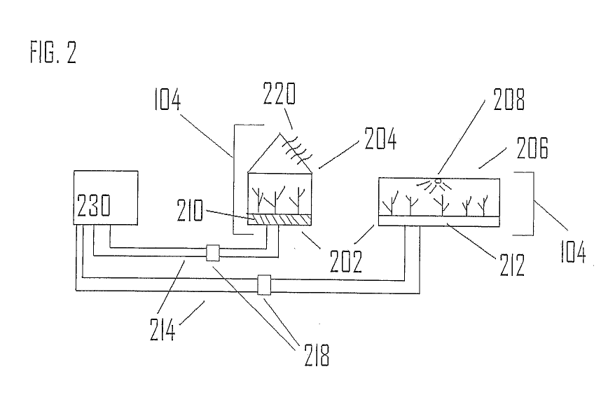

The present invention envisions at least one agricultural unit 104 connected to the other components of the system 100. Preferred embodiments present invention foresees more than one agricultural unit 104 connected to the system 100. As seen FIG. 2, the agricultural unit 104 is envisioned as having at least one atmospherically sealed unit 202. FIG. 2 depicts a plurality of agricultural units 104, each having a sealed unit 202. The sealed unit 202 can incorporate structural elements of a greenhouse, (e.g. transparent roof and walls) 204 and use solar energy 220 primarily for light and heat, with artificial light for use at night and on cloudy days. In the alternative, the sealed unit 202 can be a non-transparent structure 206, employing the use of artificial lighting 208. Furthermore, the agricultural unit 104 can be a soil-based unit, wherein the agricultural products are gown in a soil medium an/or artificial soil growth medium 210. In the alternative, the agriculture unit can employ the use of a hydroponic system wherein nutrient rich water is used as a growing medium 212. Regardless of the growing medium, the atmosphere in the agricultural unit contains a higher concentration of carbon dioxide (CO₂).

The power unit 102 produces, as a by production of the conversion of waste into energy, CO₂. The CO₂ storage unit 230 is capable of storing or transferring CO₂ in gaseous and other forms. The present invention contemplates that the pyrolysis-gasification generator employs the use of carbon sequesters to capture CO₂ and is capable of extracting CO₂ from the carbon sequesters and directing the Co₂ to agricultural facilities. The CO₂ is then used to enhance the growth and yield of the high value agricultural products.

The CO₂ storage unit can be a separate facility, a portion of the power unit 102, or any combination thereof. CO₂ is stored and transmitted in specific quantities via the conduits 214 depending on the specific needs of the each agricultural unit 104. It is envisioned that the present invention is capable of generating and transporting sufficient quantities of CO₂ to a sealed environment to promote increased growing times and larger yields.

In the present invention it is contemplated that there is a programmable control unit (not shown), a sensor (not shown) and a controllable valve 218. The sensor measures the CO₂ concentration within the agricultural unit 104 and determines when the CO₂ concentration has achieved acceptable levels. The control unit then closes the valve in order to maintain the concentration level in the agricultural unit. This allows for multiple agricultural units to achieve different levels of CO₂ concentration, depending on the crops desired, while the CO₂ storage unit maintains a reserve of CO₂. In a preferred embodiment, the agricultural unit 104 would have an atmospheric CO₂ level higher than that in standard atmospheric levels. It is envisioned that the level of CO₂ can be maintained sufficiently high so as to allow for up to 40% increase in crop yield characteristics, such as size, growth rate, CO₂ absorption and other desirable characteristics. Furthermore, factors affecting the growth of crops, e.g. light cycle, humidity, nitrogen and oxygen levels, pH, water levels, temperature and proximity to harvesting facilities are all monitored and modified in the sealed units 204 of the system 100.

It is further envisioned that the control unit can employ the valve 218, sensors and carbon storage unit 230 can be used to reduce the ambient CO2 concentration in the agricultural unit to as to allow human operators access to the sealed growing areas without special respiration assistance.

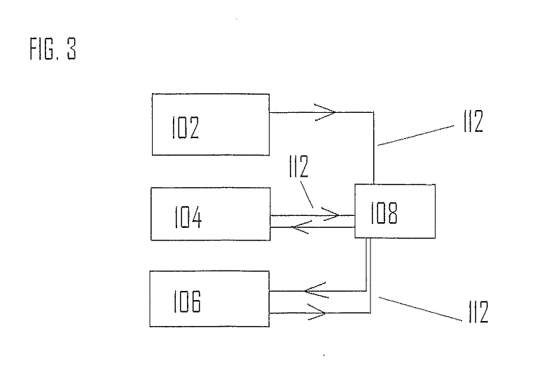

As shown in FIG. 3, the filtration unit 108 is envisioned as filtration unit that can accept waste water streams from the agricultural unit 104, the aquaculture unit 106 and the power unit 102. The filtration unit 108 accepts waste water from the power unit 102, and distributes filtered water it to the agricultural 104 and aquaculture 106 units. The filtration unit 108 also accepts waste from the aquaculture unit 106 and agricultural units 104 and filters the waste for use as marine life food stock and fertilizer. Material unsuitable for reuse in the aquaculture unit 106 and agricultural unit 104 are transported to the power unit 102 for use as fuel stock.

In a particular embodiment of the present invention, gaseous oxygen from the aquaculture unit 106, can be captured and stored. Through photosynthesis of certain marine life forms such as algae, excess oxygen is captured and stored in an oxygen storage facility (not shown) configured as a portion of the filtration unit 108. The oxygen can be used to create ozone, to more efficiently filter and purify the water. Additionally, the excess oxygen can be introduced into the agricultural units or secured in vessels for transport or sale.

The present invention is also directed to a method of increasing yields while decreasing environmental impact. The present invention provides for using an on-site pyrolysis-gasification generator to produce water, CO₂, heat and electricity. The CO₂ is sequestered and transported to the agriculture units. Additionally, water generated from the waste conversion process is also captured and directed to the agriculture and aquaculture units and recycled for system cooling. The CO₂ is directed to the sealed portion of the agriculture unit and is used to maintain a desired level of CO₂ atmospheric concentration. Any waste generated is transported back to the pyrolysis-gasification generator and is used as a fuel source.

It is envisioned that the material transfer conduits can be manual delivery conduits, pneumatic tubing, conveyer belts, or any means of conveying solid and/or semi-solid matter.

It should be understood that various combination, alternatives and modifications of the present invention could be devised by those skilled in the art. The present invention is intended to embrace all such alternatives, modifications and variances that fall within the scope of the appended claims.

While the invention has been particularly shown and described with reference to preferred embodiments thereof, it will be understood by those skilled in the art that various changes in form and details may be made therein without departing from the spirit and scope of the invention.

What is claimed is:

1. An integrated aquaculture and agriculture production system comprising:
at least one aquaculture unit;
at least one atmospherically sealed agriculture unit;
at least one on-site power unit, wherein the at least one on-site power unit comprises a pyrolysis gasification based power generation facility;
a filter unit; and
a plurality of material, thermal and electrical connectors for connecting the power unit, the atmospherically sealed agriculture unit, aquaculture unit and the filter unit to each other.

2. The integrated aquaculture and agriculture system claim 1, wherein said on-site pyrolysis gasification facility is adapted to sequester CO₂ in a CO₂ storage device.

3. The integrated aquaculture and agriculture system of claim 2, wherein the CO₂ storage device is configured to provide at least one atmospherically sealed agriculture unit with CO₂.

4. The integrated aquaculture and agriculture production system of claim 1, wherein said aquaculture unit comprises a plurality of marine life hatcheries.

5. The integrated aquaculture and agriculture production system of claim 4, wherein the aquaculture unit further comprising an algae reactor adapted to grow algae.

6. The integrated aquaculture and agriculture production system of claim 1, wherein said atmospherically sealed agricultural unit is greenhouse.

7. The integrated aquaculture and agriculture production system of claim 1, wherein said atmospherically sealed agricultural unit is a non light-transparent facility.

8. The integrated aquaculture and agriculture production system of claim 6 and 7, wherein a plurality of atmospherically sealed agricultural units are stacked vertically.

9. The integrated aquaculture and agriculture production system of claim 1, wherein the material, electrical and thermal connections comprises a plurality of conduits adapted to circulate water, CO₂, thermal energy and waste material between a plurality of power units, atmospheric sealed agriculture units, filter units and aquaculture units.

10. The integrated aquaculture and agriculture production system of claim 1, wherein the pyrolysis-gasification generator is adapted to process carbon containing municipal waste as a fuel source.

11. The integrated aquaculture and agriculture production system of claim 10, wherein the pyrolysis-gasification generator is adapted to remove excess water from the municipal waste.

12. The integrated aquaculture and agriculture production system of claim 10, wherein waste produced by the aquaculture unit and the agriculture unit can be used as a fuel source for the pyrolysis gasification generator.

13. The integrated aquaculture and agriculture production system of claim 10, wherein the carbon containing municipal waste comprises: forest, agricultural and cellulosic construction and demolition materials, municipal solid waste, sewer sludge, animal carcasses, animal manure, fish waste, medical waste, hazardous waste and industrial waste.

14. The integrated aquaculture and agriculture production system of claim 1, wherein waste heat from the pyrolysis-gasification generator is transferred by at least one thermal connector to at least one aquaculture unit.

15. The integrated aquaculture and agriculture production system of claim 8, wherein the atmospherically sealed agricultural units uses a soil or liquid based growing medium.

16. The integrated aquaculture and agriculture production system of claim 1, wherein the pyrolysis-gasification generator is adapted to generate biochar and other forms of charcoal from high carbon content waste.

17. The integrated aquaculture and agriculture production system of claim 1, wherein the filter unit is adapted to filter both solids and liquids.

18. A method for producing increased production yields at lower environmental cost using an aquaculture and agriculture production system comprising an aquaculture unit, a sealed agriculture unit, a filtration unit and a power unit comprising the steps of:
utilizing municipal waste as fuel for an on-site pyrolysis-gasification power unit to generate thermal energy, water, CO₂ and electrical energy;
a first providing step for providing the electrical and thermal energy to at least one agriculture and aquaculture unit;
a first recovering step of recovering CO₂ and water from the pyrolysis-gasification process;
transporting CO₂ to at least one agricultural unit and transporting water to at least one agriculture unit and aquaculture unit;
maintaining a desired concentration of CO₂ within the agriculture unit;
a second recovery step of recovering waste material from at least one agriculture and aquaculture unit; and
a second providing step of providing recovered waste material as a fuel source for the on-site pyrolysis-gasification generator.
